(19) United States
(12) Patent Application Publication
(10) Pub. No.: US 2024/0389200 A1
(43) Pub. Date: Nov. 21, 2024

(54) FLUID TRANSPORTATION SYSTEMS FOR PRESENTING ATMOSPHERIC EFFECTS RELATING TO AN EVENT

(71) Applicant: Sphere Entertainment Group, LLC, New York, NY (US)

(72) Inventor: Michael RIVES, Orlando, FL (US)

(73) Assignee: Sphere Entertainment Group, LLC, New York, NY (US)

(21) Appl. No.: 18/319,123

(22) Filed: May 17, 2023

(51) Int. Cl. H05B 3/42; A63J 5/02; F16L 3/22; F16L 53/38

(52) U.S. Cl. CPC H05B 3/42; A63J 5/02; F16L 3/221; F16L 53/38; A63J 2005/006; A63J 2005/008

(57) ABSTRACT

A system for transporting a fluid from a fluid source to an effects pod to provide atmospheric effects to an audience in a venue can include a pipe assembly. The pipe assembly can include a pipe for fluid communication with the fluid source, a connector disposed at an end of the pipe to couple to at least one of a flexible conduit or another pipe assembly, and a pipe support coupled to the pipe, such that a lower portion of the pipe support contacts a ground surface to hold the pipe a distance above the ground surface. The pipe assembly can further include insulation abutting at least a portion of the pipe. Additionally, the pipe assembly can include a heat trace in contact with the pipe. The system can include a cart to transport the pipe assembly. A plurality of pipe assemblies can be connected in series to transport the fluid from the fluid source to the effects pod.

### BACKGROUND

The United States Media and Entertainment Industry is the largest in the world. The United States Media and Entertainment Industry represents a third of the global media and entertainment industry which delivers events, such as musical events, theatrical events, sporting events, and/or motion picture events, to an audience for their viewing pleasure. Presently, venues, such as music venues and/or sporting venues to provide an example, deliver these events to the audience using audio-visual systems having various display screens surrounded by auditory speakers. Operators of these venues have made many attempts to further enhance the immersion of the audience as they are viewing these events. For example, these operators have used large flames to deliver conventional heating effects to the audience, but these large flames cannot be used within indoor venues and pose fire concerns. Other conventional heating systems, such as large radiant space heaters, have also been used to deliver the conventional heating effects, but these conventional heating systems are extremely inefficient, require an almost limitless amount of power, and also pose fire concerns. Operators of these venues have used large air blowers, such as large industrial fans to provide an example, to deliver conventional cooling effects to the audience, but these large air blowers have difficulty in providing a large enough air volume to deliver these conventional cooling effects to the entire audience.

Some venues require the transportation of fluids (e.g., steam or air) between locations in the venue. In some cases, the fluids can be transported using a hose and can be used to provide the effects described. Transportation of heated fluids using hoses can pose a burn hazard. Further, hoses lying on a ground surface can pose a tripping hazard. Additionally, hoses can melt due to high temperature fluids. Pipes can also be used to transport fluids. However, pipes can require welding, which can require labor and can be time consuming.

### BRIEF SUMMARY

Accordingly, there is a need to provide a fluid transportation system and method that can prevent hazards related to burns or tripping. Further, there is a need to provide a fluid transportation system that is durable and requires minimal labor and time to transport and assemble.

In an aspect, a system for transporting a food grade fluid from a fluid source to an effects pod to provide atmospheric effects to an audience in a venue can include a pipe assembly. In an aspect, the pipe assembly can include a pipe for fluid communication with the fluid source. In an aspect, the pipe assembly can further include a connector disposed at an end of the pipe to couple to a flexible conduit. In an aspect, the pipe assembly can further include a pipe support coupled to the pipe, such that a lower portion of the pipe support can contact a ground surface to hold the pipe a distance above the ground surface. In an aspect, the system can further include a cart to transport the pipe assembly. In an aspect, the cart can include a rack to retain the pipe assembly.

In an aspect, the system can include a plurality of pipe assemblies to be connected in series via a plurality of flexible conduits. In an aspect, the rack can include a plurality of channels to receive a plurality of pipe supports of the plurality of pipe assemblies.

In an aspect, the pipe assembly can further include insulation abutting at least a portion of the pipe. In an aspect, the pipe assembly can further include a heat trace in contact with the pipe. In an aspect, the pipe assembly can further include a sensor to measure a temperature of an exterior surface of the pipe.

In an aspect, the heat trace can be a first heat trace, and the pipe assembly can further include a first electrical connector coupled to an end of the first heat trace to couple the first heat trace to a second heat trace in contact with a first flexible conduit. In an aspect, the pipe assembly can further include a second electrical connector coupled to an opposite end of the first heat trace to couple the first heat trace to a third heat trace in contact with a second flexible conduit.

In an aspect, the pipe assembly can sustain a temperature of at least about 150° C. on the exterior surface of the pipe. In an aspect, the pipe assembly can sustain a temperature under about 50° C. on an exposed surface of the pipe assembly.

In an aspect, the lower portion of the pipe support can contact the ground surface to hold the pipe the distance above the ground surface while not being fixed to the ground surface. In an aspect, the distance can be about 1 inch to about 1.3 feet. In an aspect, the ground surface can be a performance stage.

In an aspect, the fluid source can be a steam generator. In an aspect, the fluid source can be positioned outside the venue.

In an aspect, an interior surface of the pipe can include a food grade material. In an aspect, the pipe can include stainless steel.

In an aspect, a pipe assembly can include a pipe for fluid communication with a fluid source. In an aspect, the pipe assembly can further include a connector disposed at an end of the pipe to couple to at least one of a flexible conduit or another pipe assembly. In an aspect, the pipe assembly can further include a pipe support coupled to the pipe, such that a lower portion of the pipe support can contact a ground surface to hold the pipe a distance above the ground surface. In an aspect, the pipe assembly can further include insulation abutting at least a portion of the pipe.

In an aspect, the pipe assembly can further include a heat trace in contact with the pipe. In an aspect, the pipe assembly can further include a sensor to measure a temperature of an exterior surface of the pipe. In an aspect, the heat trace can be a first heat trace and the pipe assembly can be a first pipe assembly, and the first pipe assembly can further include a first electrical connector coupled to an end of the first heat trace to couple the first heat trace to a second heat trace in contact with a first flexible conduit or a second pipe assembly. In an aspect, the first pipe assembly can further include a second electrical connector coupled to an opposite end of the first heat trace to couple the first heat trace to a third heat trace in contact with a second flexible conduit or a third pipe assembly.

In an aspect, the pipe assembly can sustain a temperature of at least about 150° C. on the exterior surface of the pipe. In an aspect, the pipe assembly can sustain a temperature under about 50° C. on an exposed surface of the pipe assembly.

In an aspect, the lower portion of the pipe support can contact the ground surface to hold the pipe the distance above the ground surface while not being fixed to the ground surface. In an aspect, the distance can be about 1 inch to about 1.3 feet. In an aspect, the ground surface can be a performance stage.

In an aspect, the fluid source can be a source of food grade fluid. In an aspect, an interior surface of the pipe can include a food grade material. In an aspect, the pipe can include stainless steel.

In an aspect, a method for transporting a fluid from a fluid source to an effects pod to provide atmospheric effects to an audience in a venue can include coupling a pipe assembly to the fluid source. In an aspect, the pipe assembly can include a pipe for fluid communication with the fluid source. In an aspect, the pipe assembly can further include a heat trace in contact with the pipe. In an aspect, the pipe assembly can further include insulation abutting at least a portion of the pipe and the heat trace. In an aspect, the pipe assembly can further include a pipe support coupled to the pipe, such that a lower portion of the pipe support can contact a ground surface to hold the pipe a distance above the ground surface. In an aspect, the method can further include coupling the pipe assembly to the effects pod. In an aspect, the method can further include controlling a temperature of a fluid using a controller coupled to the heat trace while transporting the fluid from the fluid source, through the pipe, and to the effects pod. In an aspect, the atmospheric effects can include the fluid.

In an aspect, the method can further include coupling the pipe assembly to at least one of the effects pod or the fluid source using a flexible conduit.

In an aspect, the pipe support can be unfixed to the ground surface.

In an aspect, the fluid source can be a steam generator. In an aspect, the fluid

source can be positioned outside the venue. In an aspect, the fluid can be food grade.

### BRIEF DESCRIPTION OF THE DRAWINGS

Aspects of the present disclosure are best understood from the following detailed description when read with the accompanying figures. It is noted that, in accordance with the standard practice in the industry, features are not drawn to scale. In fact, the dimensions of the features can be arbitrarily increased or reduced for clarity of discussion.

FIG. 1A is a perspective view of a pipe assembly, according to an aspect.

FIG. 1B is a side view of a pipe assembly, according to an aspect.

FIG. 2 is a front view of a pipe support, according to an aspect.

FIG. 3 is an exploded perspective view of a pipe support, according to an aspect.

FIG. 4 is a front view of a pipe support, according to an aspect.

FIG. 5A is a perspective view of a cart for transporting pipe assemblies such as the pipe assembly shown in FIGS. 1A-1B, according to an aspect.

FIG. 5B is a top view of a cart for transporting pipe assemblies such as the pipe assembly shown in FIGS. 1A-1B, according to an aspect.

FIG. 5C is a side view of a cart for transporting pipe assemblies such as the pipe assembly shown in FIGS. 1A-1B, according to an aspect

FIG. 6 is an exploded perspective view of a fluid transport system, according to an aspect.

FIG. 7 is a perspective view of the fluid transport system shown in FIG. 6, according to an aspect.

FIG. 8 is a diagram of an atmospheric effects system, according to an aspect.

FIG. 9 is a diagram of an atmospheric effects system, according to an aspect.

### DETAILED DESCRIPTION

The following disclosure provides many different aspects, or examples, for implementing different features of the provided subject matter. Specific examples of components and arrangements are described below to simplify the present disclosure. These are, of course, merely examples and are not intended to be limiting. For example, the formation of a first feature over a second feature in the description that follows can include aspects in which the first and second features are formed in direct contact, and can also include aspects in which additional features can be formed between the first and second features, such that the first and second features are not in direct contact. In addition, the present disclosure can repeat reference numerals and/or letters in the examples. This repetition does not in itself dictate a relationship between the aspects and/or configurations discussed.

### Exemplary Pipe Assembly

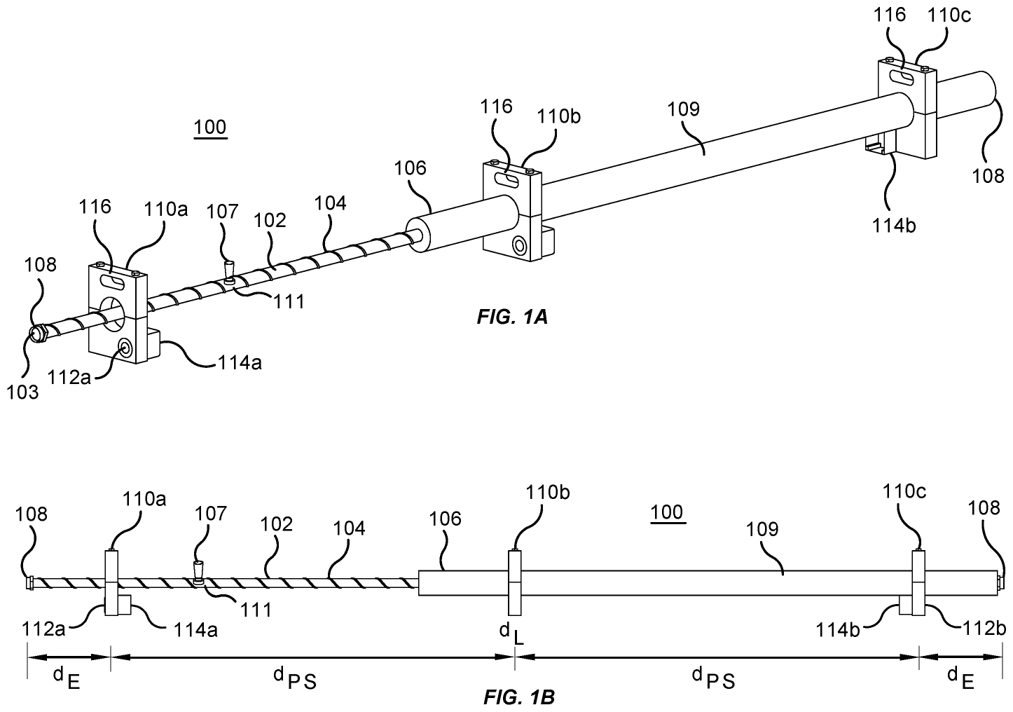

FIGS. 1A and 1B show a pipe assembly 100. Pipe assembly 100 can include a pipe 102 for fluid communication with a fluid source. Pipe 102 can be a rigid conduit. Accordingly, pipe 102 can be distinguished from a hose, which can bend when a force is exerted upon it. Pipe 102 can be any suitable rigid material, for example, copper, chromed copper, stainless steel, galvanized iron, Poly-Vinyl Chloride (PVC), Chlorinated Poly-Vinyl Chloride (CPVC), or Cross-linked Polyethylene (PEX). Pipe 102 can be any suitable rigid material that can withstand the elevated operating temperatures described in the present disclosure. In an aspect, an interior surface 103 of pipe 102 can be a food grade material. For example, as noted above, pipe 102 can be stainless steel.

Pipe assembly 100 can further include a heat trace 104 to control a temperature of pipe 102. Accordingly, heat trace 104 can control the temperature of a fluid within pipe 102. Heat trace 104 can be wound around pipe 102 and can be in contact with pipe 102 such that portions of pipe 102 are not covered by heat trace 104, as shown in FIG. 1A. In an aspect, heat trace 104 can be a power limiting heating cable, for example, a 100-120 V 15 W/ft nVent RAYCHEM VPL power-limiting heating cable or any other suitable power-limiting heating cable. In another aspect, heat trace 104 can be a self-regulating heating cable. In an aspect, heat trace 104 can be attached to pipe 102 using fixing tape, for example, nVent RAYCHEM GS-54 fixing tape or any other suitable fixing tape. In an aspect, heat trace 104 can be wound around and in contact with the full length of pipe 102. In another aspect, heat trace 104 can be wound around and in contact with only a portion of the length of pipe 102. In another aspect, heat trace 104 can be positioned linearly along pipe 102 and in contact with pipe 102 without being wound around pipe 102. In another aspect, pipe assembly 100 can be utilized without a heat trace 104.

Pipe assembly 100 can further include insulation 106 to retain the fluid temperature within pipe 102. In addition, insulation 106 can prevent contact burns to users by maintaining a low temperature (e.g., at or below 50° C.) on an exposed surface 109 of pipe assembly 100. In an aspect, exposed surface 109 can be insulation 106. In another aspect, exposed surface 109 can be other materials and/or layers surrounding insulation 106. For example, exposed surface 109 can be a foil, such as aluminum foil or titanium foil, wrapped around insulation 106. Exposed surface 109 can be exhaust header tape, also known as exhaust manifold tape, wrapped around insulation 106.

Insulation 106 can abut heat trace 104 and/or pipe 102. For example, insulation 106 can encase pipe 102 and/or heat trace 104 and can abut portions of pipe 102 not covered by heat trace 104. In an aspect, insulation 106 can be disposed along a full length of pipe assembly 100. For example, while FIGS. 1A-1B show insulation 106 disposed along only a portion of the length of pipe assembly 100 to allow for the depiction of heat trace 104, insulation 106 can cover substantially the entirety of pipe 102. Insulation 106 can include mineral or glass wool, foam (e.g., polyethylene-or polyurethane-based foam), calcium silicate, cellular glass, an aerogel, or any other suitable heat resistant material.

Pipe assembly 100 can further include sensor 107 to measure a temperature of a surface of pipe 102. For example, sensor 107 can measure the temperature of an exterior surface 111 of pipe 102. In an aspect, sensor 107 can be a resistance temperature detector (RTD) sensor, for example, an nVent RAYCHEM RTD-10CS sensor or any other suitable RTD sensor. In another aspect, sensor 107 can be a thermocouple. In another aspect, sensor 107 can be a semiconductor-based integrated circuit (IC) temperature sensor.

Insulation 106 can prevent pipe assembly from posing a burn hazard to users. For example, the combination of heat trace 104 and insulation 106 of pipe assembly 100 can enable pipe assembly 100 to sustain a temperature of at least about 100° C. on exterior surface 111 of pipe 102. For example, pipe assembly 100 can sustain a temperature of at least about 110° C., at least about 120° C., at least about 130° C., at least about 140° C., at least about 150° C., or at least about 160° C. on exterior surface 111 of pipe 102. Meanwhile, insulation 106 can enable pipe assembly 100 to sustain a temperature under about 70° C. on exposed surface 109 of pipe assembly 100. For example, pipe assembly 100 can sustain a temperature under about 60° C., under about 50° C., or under about 40° C. on exposed surface 109 of pipe assembly 100.

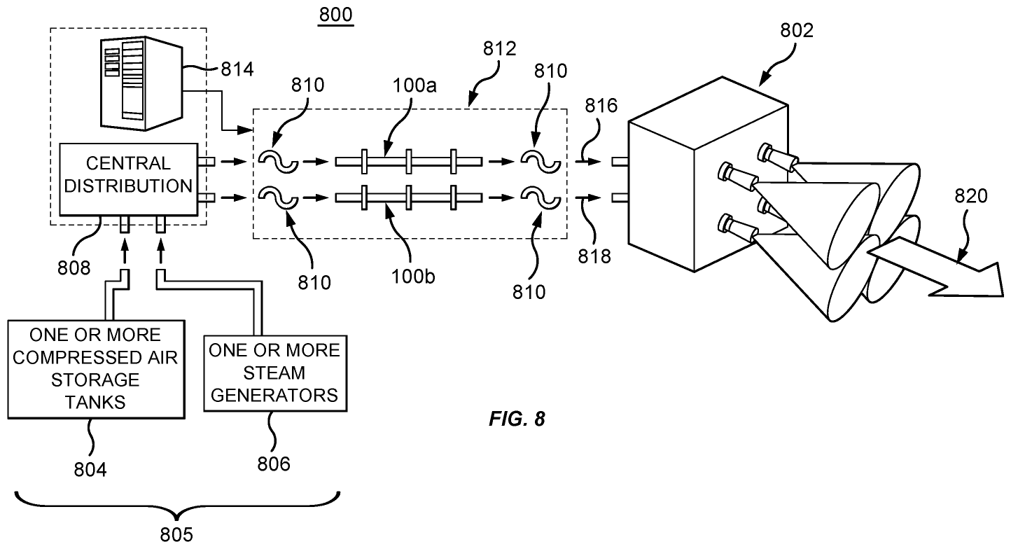

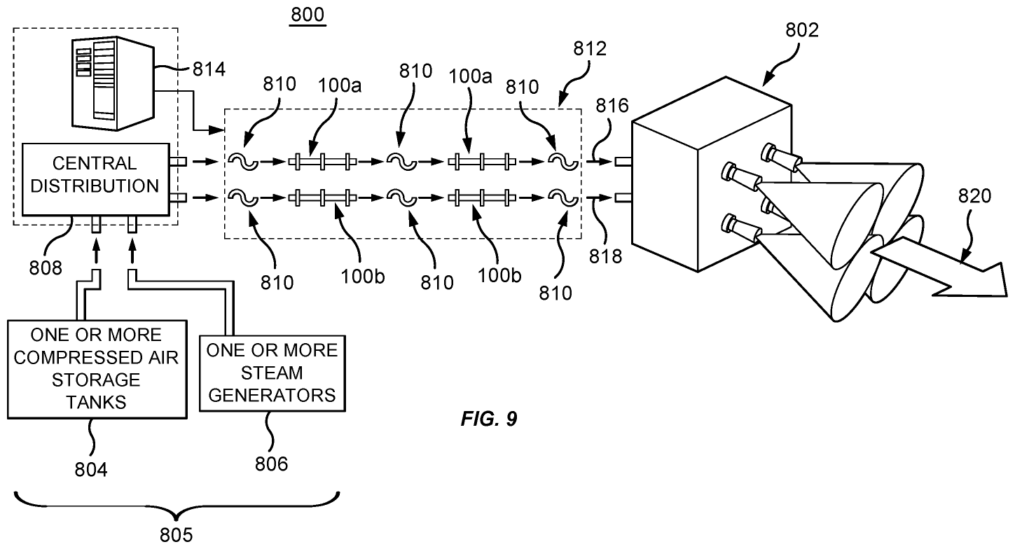

As shown in FIGS. 1A and 1B, pipe assembly 100 can further include connectors 108 to couple pipe 102 to at least one of a flexible conduit (e.g., a hose), such as a flexible conduit 810 shown in FIGS. 8-9, or another pipe assembly 100. Connectors 108 can be disposed at opposite ends of pipe 102. In an aspect, connectors 108 can be ground joint connectors, for example, Campbell Fittings GMS-8 ground joint male spuds or any other suitable ground joint connectors. Connectors 108 can be ground joint connectors to enable installation without tools, as ground joint connectors can enable leak-free connection when tightened by hand. Since many steam hoses are supplied with female ground joint connectors at both ends, in an aspect, connectors 108 can both be male connectors. To connect pipe assembly 100 to another pipe assembly 100, connectors 108 of both pipe assemblies 100 can be fitted with male/female adapters and connected using a close nipple.

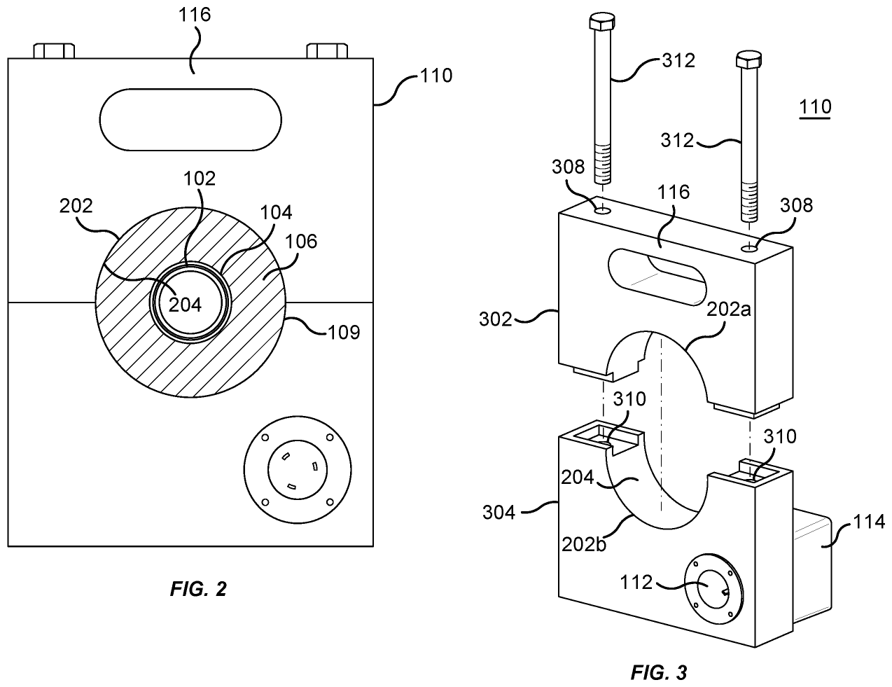

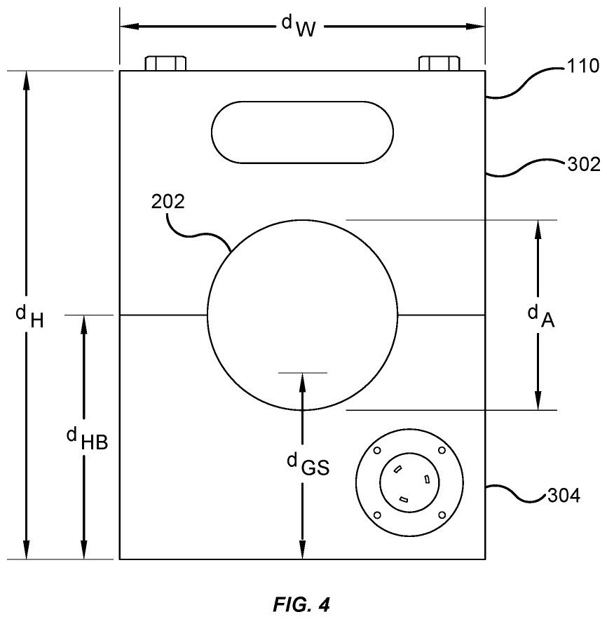

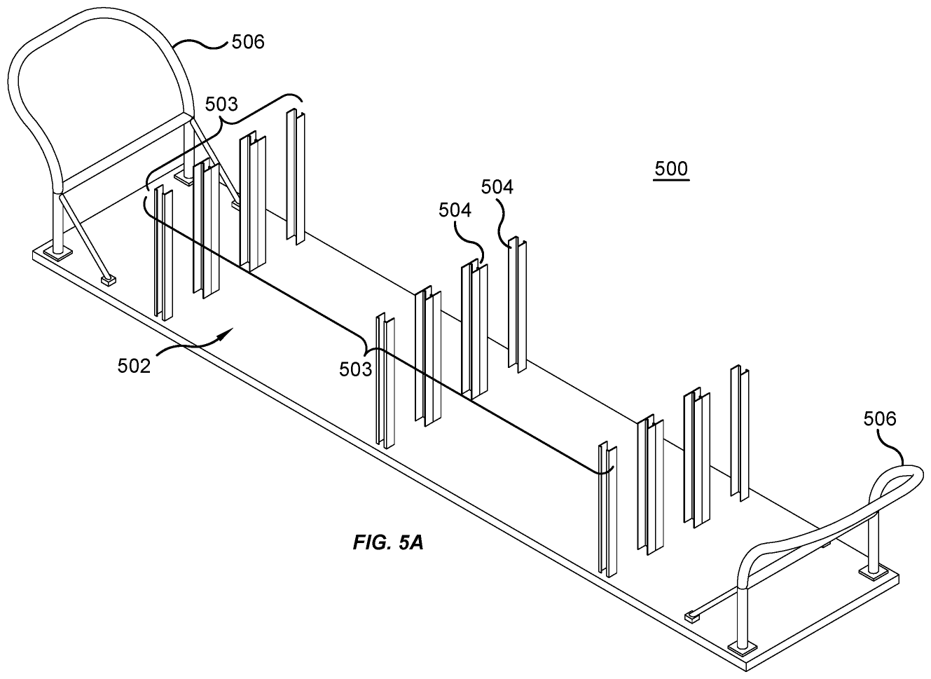

Pipe assembly 100 can further include pipe supports 110, for example, first pipe support 110a, second pipe support 110b, and third pipe support 110c. Pipe supports 110 can be coupled to pipe 102 along pipe 102 to support pipe 102 a distance above a ground surface, as discussed in more detail with respect to FIGS. 3-4. For example, pipe supports 110 can be coupled to pipe 102 and can abut exposed surface 109. More specifically, each of pipe supports 110 can surround a cross section of pipe 102, heat trace 104, and insulation 106, as shown in FIG. 2. While FIG. 1A shows three pipe supports, pipe assembly 100 can include any number of pipe supports 110, such as two, four, five, six, seven, or eight pipe supports 110. Pipe supports 110 can be spaced along the length of pipe 102.

Pipe supports 110 can support pipe 102 a distance above a ground surface while allowing pipe assembly 100 to be mobile. For example, in an aspect, pipe assembly 100 can be placed on a ground surface and supported by pipe supports 110 without pipe supports 110 being fixed to the ground surface. For example, pipe supports 110 can be unfastened to the ground surface. Therefore, pipe assembly 100 can be easily moved to a desired location and placed at a desired angle without pipe assembly 100 needing to be unfastened or fastened to a ceiling, wall, or floor. In such an aspect, pipe assembly can optionally be held in a particular configuration (i.e., angle and/or position) by inserting pipe supports 110 into grooves in the ground surface.

In another aspect, pipe supports 110 can be fixed to a ground surface when pipe assembly 100 is placed on the ground surface. For example, pipe supports 110 can be fastened to the ground surface using bolts or adhesive.

In an aspect, the ground surface can be a performance stage. In another aspect, the ground surface can be real or artificial turf of a field. In another aspect, the ground surface can be a floor in an indoor venue.

While FIG. 1A shows rectangular pipe supports 110, pipe supports 110 can be any suitable shape, such as triangular, pentagonal, hexagonal, semioval, or semicircular.

As shown in FIGS. 1A and 1B, first pipe support 110a and third pipe support 110c (or generally, pipe supports 110 on opposite ends of pipe assembly 100) can include electrical connectors 112, for example, first electrical connector 112a and second electrical connector 112b (shown in FIG. 1B), respectively. In an aspect, second pipe support 110b (or generally pipe support(s) 110 not at the ends of pipe assembly 100) can be without an electrical connector. First electrical connector 112a can be coupled to an end of heat trace 104 to couple heat trace 104 to a heat trace in contact with at least one of a flexible conduit or another pipe assembly 100. Likewise, second electrical connector 112b can be coupled to an opposite end of heat trace 104 to couple heat trace 104 to another heat trace in contact with at least one of a flexible conduit or another pipe assembly 100. Further, electrical connectors 112 can couple heat trace 104 to a controller and/or an electrical power source.

In an aspect, electrical connectors 112 can be junction boxes, for example, nVent RAYCHEM JBS-100 single-entry power junction boxes, or any other suitable junction boxes. In such an aspect, the components of first electrical connector 112a and second electrical connector 112b can be at least partially housed in enclosures 114, such as first enclosure 114a and second enclosure 114b, respectively. Further, in such an aspect, first electrical connector 112a and second electrical connector 112b can be disposed on first pipe support 110a and third pipe support 110c, respectively. In another aspect, each of first electrical connector 112a and second electrical connector 112b can be included on a power whip cable coupled to each end of heat trace 104. Implementing electrical connectors 112 on power whip cables can enable greater flexibility in the placement of pipe assembly 100 when connecting pipe assembly 100 to a flexible conduit or another pipe assembly 100. In an aspect, first electrical connector 112a can be a female connector while second electrical connector 112b can be a male connector, or vice versa.

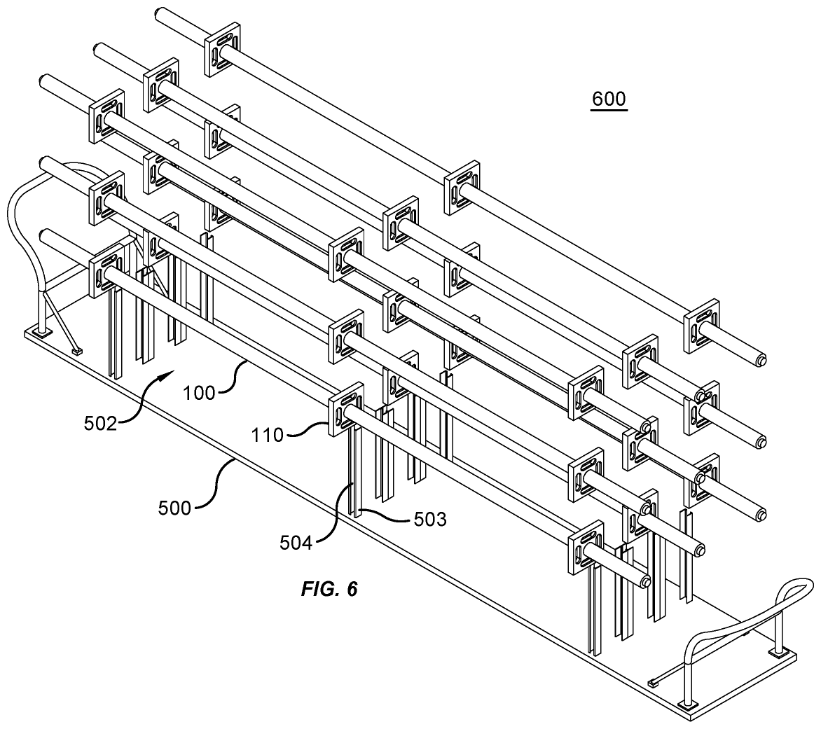

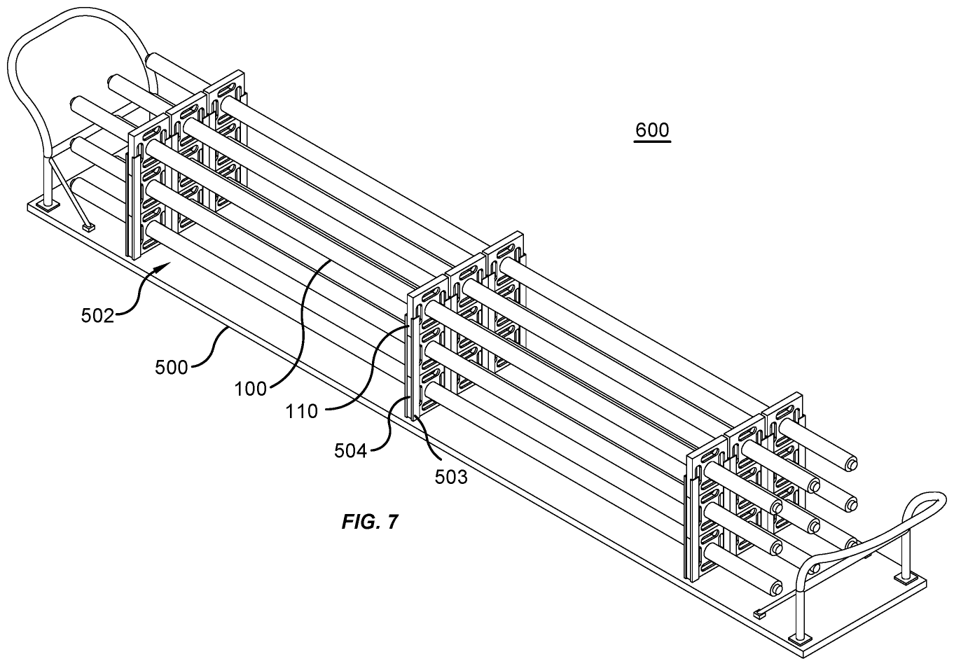

Each of pipe supports 110 can further include a handle 116 to facilitate the transportation and placement of pipe assembly 100. While FIG. 1A shows each of pipe supports 110 including a handle 116, only one or a subset of pipe supports 110 can include a handle 116. Further, while FIG. 1A shows a single handle 116 per pipe support 110, pipe supports 110 can each include multiple handles 116, such as two, three, or four handles 116 arranged around each of pipe supports 110, as shown in FIGS. 6-7. Pipe supports 110 each including multiples handles can enable pipe assembly 100 to be placed on a ground surface or storage rack in any orientation (i.e., a user does not need to consider whether handles 116 are facing a particular direction). This can enable quicker deployment or storage of pipe assembly 100.

FIG. 1B shows pipe assembly 100. As shown in FIG. 1B, pipe assembly 100 can have a total length d_{L}, defined as the distance between opposite ends of pipe assembly 100. d_{L} can be about 5 ft to about 20 ft. For example, d_{L} can be about 6 ft to about 18 ft, about 7 ft to about 16 ft, about 8 ft to about 14 ft, about 9 ft to about 12 ft, or about 10 ft to about 12 ft.

As shown in FIG. 1B, pipe supports 110 can be spaced a distance d_{PS} apart. Further, pipe supports 110a and 110c can each be spaced from the ends of pipe 102 a distance d_{E}. In an aspect, d_{PS} and d_{E} can be substantially uniform across pipe assembly 100 (i.e., pipe supports 110 can be spaced substantially evenly apart from one another and pipe supports 110a and 110c can be spaced substantially evenly from the ends of pipe 102). In another aspect, des and/or de can differ across pipe assembly 100.

In an aspect in which pipe assembly 100 has three pipe supports 110, d_{PS} can be about ¼ d_{L} to about ½ d_{L}. For example, des can be about ⅓ d_{L} to about 11/24 d_{L}, or about 5/12 d_{L}. In an aspect in which pipe assembly 100 has two pipe supports 110, d_{PS} can be about ½ d_{L} to about + 7/48 d_{L}. For example, d_{PS} can be about ⅔ d_{L} to about 11/12 d_{L}, or about ⅚ d_{L}. In either aspect, de can be about 1/48 d_{L} to about ¼ d_{L}. For example, de can be about 1/24 d_{L} to about ⅙ d_{L}, or about 1/12 d_{L}.

To ensure pipe supports 110 can provide sufficient support for pipe 102 across pipe assembly 100, d_{PS} can be about 2 ft to about 10 ft. For example, d_{PS} can be about 2 ft to about 8 ft, about 3 ft to about 7 ft, about 3 ft to about 6 ft, or about 4 ft to about 5 ft.

FIG. 2 shows a pipe support 110 engaged with a cross section of a pipe assembly 100. Pipe support 110 shown in FIG. 2 can be substantially similar to second pipe support 110b shown in FIGS. 1A-1B. However, the features of pipe support 110 of FIG. 2 described below can apply to any pipe support 110.

As shown in FIG. 2, pipe support 110 can surround a cross section of pipe 102, heat trace 104, and insulation 106. Heat trace 104 can be wound around pipe 102 and in contact with pipe 102. Since insulation 106 can be flexible, insulation 106 can compress to abut both pipe 102 and heat trace 104. In an aspect in which pipe assembly 100 does not include heat trace 104, insulation 106 can abut pipe 102 alone.

Pipe support 110 can further include an aperture 202 to receive pipe 102, heat trace 104, and insulation 106. An interior surface 204 of aperture 202 can abut exposed surface 109, which is shown as insulation 106 in FIG. 2 but can be other materials and/or layers surrounding insulation 106, as discussed above. In an aspect, interior surface 204 of aperture 202 can be secured to exposed surface 109 using an adhesive. In another aspect, interior surface 204 of aperture 202 can be secured to exposed surface 109 via pressure (i.e., the sides of aperture 202 can compress insulation 106 to an extent such that pipe support 110 is generally fixed with respect to exposed surface 109 via a resulting frictional force). In another aspect, interior surface 204 of aperture 202 can be secured to exposed surface 109 using both an adhesive and pressure.

In an aspect, aperture 202 can be positioned in the center of pipe support 110, as shown in FIG. 2. In another aspect, aperture 202 can be positioned closer to the top (e.g., the portion of pipe support 110 near handle 116 in FIG. 2) of pipe support 110 than the bottom. In another aspect, aperture 202 can be positioned closer to the bottom of pipe support 110 than the top.

### Exemplary Pipe Support

FIG. 3 shows an exploded view of a pipe support 110. Pipe support 110 shown in FIG. 3 can be substantially similar to first pipe support 110a shown in FIGS. 1A-1B. However, the features of pipe support 110 of FIG. 3 described below can apply to any pipe support 110.

As shown in FIG. 3, pipe support 110 can include an upper portion 302 and a lower portion 304. In an aspect, pipe support 110 can further include holes 308, 310 and fasteners 312 to join upper portion 302 to lower portion 304. For example, fasteners 312 can be inserted through holes 308 in upper portion 302 and into holes 310 in lower portion 304. Holes 310 and fasteners 312 can be threaded, such that fasteners 312 can be secured within holes 310 to tighten the attachment of upper portion 302 to lower portion 304. In such an aspect, fasteners 312 can be bolts or screws. In another aspect, upper portion 302 and lower portion 304 can be joined using adhesive, rather than holes 308, 310 and fasteners 312.

Pipe support 110 can include two portions, upper portion 302 and lower portion 304, so that pipe support 110 can be secured around pipe 102, heat trace 104, and insulation 106. For example, pipe 102, heat trace 104, and insulation 106 can be placed in the portion of aperture 202 (shown as 202b) in lower portion 304. Then, upper portion 302 can be placed over pipe 102, heat trace 104, and insulation 106 such that the portion of aperture 202 (shown as 202a) in upper portion 302 accommodates pipe 102, heat trace, and insulation 106. Pressure can be required to join upper portion 302 to lower portion 304. Accordingly, in an aspect, fasteners 312 can be inserted into holes 308, passed through upper portion 302 and into holes 310, and tightened to compress insulation 106 within aperture 202 and join upper portion 302 to lower portion 304. In another aspect, upper portion 302 can be pressed without using fasteners 312 to compress insulation 106 within aperture 202 and join upper portion to lower portion 304 using an adhesive applied between upper portion 302 and lower portion 304.

FIG. 4 shows a pipe support 110. Pipe support 110 shown in FIG. 4 can be substantially similar to first pipe support 110a shown in FIGS. 1A-1B. However, the features of pipe support 110 of FIG. 4 described below can apply to any pipe support 110.

As shown in FIG. 4, pipe support 110 can have a height d_{H}. d_{H} can be about 4 in to about 1.5 ft. For example, d_{H} can be about 6 in to about 1.5 ft, about 8 in to about 1.5 ft, about 10 in to about 1.5 ft, about 1 ft to about 1.5 ft, about 1.2 ft to about 1.5 ft, or about 1.3 ft.

Pipe support 110 can further have a width d_{W}. d_{W} can be about 4 in to about 1.5 ft. For example, d_{W} can be about 5 in to about 1.5 ft, about 6 in to about 1.5 ft, about 7 in to about 1.4 feet, about 8 in to about 1.3 ft, or about 1 ft.

Lower portion 304 of pipe support 110 can have a height d_{HB}. d_{HB} can be about 2 in to about 1.4 ft. For example, d_{HB} can be about 3 in to about 1.3 ft, about 4 in to about 1.2 ft, about 5 in to about 1 ft, about 6 in to about 10 in, or about 8 in.

Aperture 202 of pipe support 110 can have a diameter d_{A}. d_{A} can be about 1 in to about 1 ft. For example, d_{A} can be about 2 in to about 11 in, about 3 in to about 10 in, about 4 in to about 9 in, about 5 in to about 8 in, about 6 in to about 7 in, or about 6.25 in.

The values of d_{HB} and d_{A} can determine a distance dos pipe 102 is supported above a ground surface by pipe support 110. das can be about 1 in to about 1.3 ft. For example, d_{GS} can be about 2 in to about 1.2 ft, about 3 in to about 1 ft, about 4 in to about 10 in, about 5 in to about 8 in, or about 6.5 in. das can be such that pipe assembly 100 is easily visible on the ground surface, reducing the tripping hazard posed by pipe assembly 100.

### Exemplary Cart and Fluid Transport System

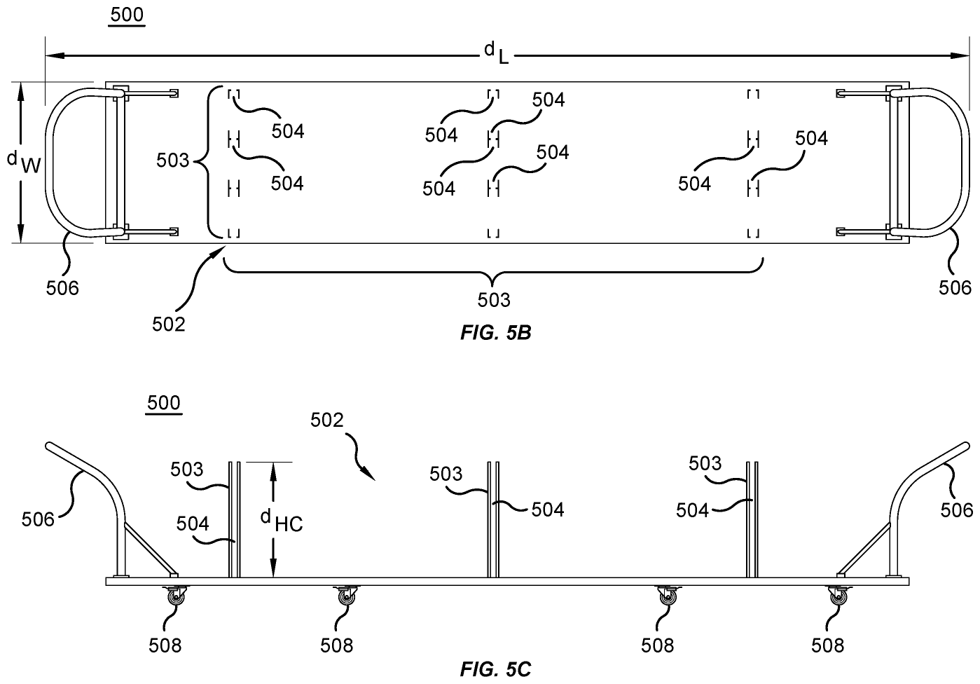

FIG. 5A shows a cart 500 to transport at least one pipe assembly 100. Cart 500

can include a rack 502 to retain at least one pipe assembly 100. To retain pipe assemblies 100, rack 502 can include a plurality of supports 503 that form a plurality of channels 504 to receive pipe supports 110 of pipe assemblies 100. Supports 503 can be spaced in accordance with the width d_{W} of pipe supports 110. Additionally, supports 503 can be spaced such that channels 504 can have a width which slightly exceeds a thickness of pipe supports 110. Accordingly, pipe supports 110 can be inserted into channels 504 and secured on rack 502, as shown in FIG. 7. While FIG. 5A shows 18 channels 504 each capable of receiving three pipe supports 110 (as shown in FIG. 7), any number of channels 504 can be included in rack 502 depending on the number of pipe supports 110 per pipe assembly 100 and the number of pipe assemblies retained by rack 502. Further the height of each channel 504 can be such that fewer or more pipe supports 110 can be received. For example, one, two, four, five, or six pipe supports 110 can be received and stacked vertically within a channel 504.

Pipe assemblies 100 can be stored on cart 500. Additionally, cart 500 can facilitate the movement of pipe assemblies 100 to various points within a venue. Pipe assemblies 100 can be removed from cart 500 and placed on a ground surface. Cart 500 can further include handles 506 and wheels 508 (shown in FIG. 5C) to facilitate movement of cart 500.

FIG. 5B shows cart 500. As shown in FIG. 5B, cart 500 can have a length d_{L}. d_{L} can be about 7 ft to about 25 ft. For example, d_{L} can be about 8 ft to about 22 ft, about 9 ft to about 20 ft, about 10 ft to about 18 ft, about 11 ft to about 16 ft, or about 12 ft to about 14 ft.

Cart 500 can further have a width d_{W}. d_{W} can be about 2 ft to about 8 ft. For example, d_{W} can be about 2 ft to about 7 ft, about 2 ft to about 6 ft, about 3 ft to about 5 ft, or about 4 ft.

In an aspect, cart 500 can be sized such that cart 500 can fit within a freight elevator with a platform of about 14 ft×about 20 ft. For example, cart 500 can be sized such that cart 500 can fit within a freight elevator with a platform of about 12 ft×about 20 ft, about 12 ft×about 16 ft, about 12 ft×about 12 ft, about 10 ft×about 14 ft, or about 10 ft×about 12 ft. Cart 500 fitting within a freight elevator in a venue can enable pipe assemblies 100 to be transported between floors of the venue.

FIG. 5C shows cart 500. As shown in FIG. 5C, rack 502 can have a height corresponding to a height d_{HC} of a channel 504. d_{HC} can be about 2 ft to about 6 ft. For example, d_{HC} can be about 2.5 ft to about 5.5 ft, about 3 ft to about 5 ft, about 3.5 ft to about 4.5 ft, or about 4 ft. As noted above, d_{HC} can be selected such that channel 504 can receive three pipe supports 110 stacked vertically. However, depending on the height d_{H} of pipe supports 110 and on d_{HC}, channel 504 can receive fewer or additional pipe supports 110, such as one, two, four, five, or six pipe supports 110.

FIGS. 6-7 show a fluid transport system 600 for transporting a plurality of pipe assemblies 100. As shown in FIGS. 6-7, a pipe support 110 of a pipe assembly 100 can be received by a channel 504 of rack 502. While FIGS. 6-7 show nine pipe assemblies 100 being loaded onto cart 500, depending on the numbers and sizes of supports 503, channels 504, and pipe supports 110, fewer or additional pipe assemblies 100, such as two, three, four, six, eight, nine, 10, 12, 14, 15, 16, 18, or 20 pipe assemblies 100, can be loaded onto and transported by cart 500.

In an aspect, cart 500 can include an area to store and/or transport flexible conduits used to connect pipe assemblies 100. In another aspect, fluid transport system 600 can include another cart similar to cart 500 for storing and/or transporting flexible conduits used to connect pipe assemblies 100.

### Exemplary Atmospheric Effects System

FIG. 8 shows a block diagram of an atmospheric effects system 800 for providing atmospheric effects to an audience in a venue. Atmospheric effects system 800 can include features of the atmospheric effects systems described in U.S. application Ser. No. 16/997,511 (attorney docket no. 3804.0130000; now U.S. Pat. No. 11,260,314) and U.S. application Ser. No. 16/997,518 (attorney docket no. 3804.0140000; now U.S. Pat. No. 11,266,921), the disclosures of which are incorporated herein by reference in their entireties. In an aspect, pipe assemblies 100 can be used within atmospheric effects system 800 for transporting fluids, as described below. In another aspect, pipe assemblies 100 can be used for transporting fluids generally, either inside or outside a venue, and either inside or outside an atmospheric effects system 800.

In the aspect shown in FIG. 8, atmospheric effects system 800 can provide various atmospheric effects 820 relating to an event, such a musical event, a theatrical event, a sporting event, a motion picture, and/or any other suitable event that will be apparent to those skilled in the relevant art(s) without departing the spirit and scope of the present disclosure. In some aspects, these atmospheric effects 820 can include an idle stream of air, a breeze stream of air, a blast stream of air, a cold stream of air, a cold breeze stream of air, a cold blast stream of air, a warm stream of air, a warm breeze stream of air, a warm blast stream of air, a scented stream of air, and/or any combination thereof.

In an aspect, the idle stream of air can be characterized as being a stream of air having a slow speed, for example, less than about 2 MPH, at a substantially similar temperature as the venue. In an aspect, the breeze stream of air can be characterized as being a stream of air having a medium speed, for example, between about 2 MPH and about 7 MPH, at a substantially similar temperature as the venue. In an aspect, the blast stream of air can be characterized as being a stream of air having a high speed, for example, greater than about 7 MPH, at a substantially similar temperature as the venue. In an aspect, the cold stream of air can be characterized as being a stream of air having the slow speed at a colder temperature than the venue, for example, at least about 4 degrees or more colder than the temperature of the venue. In an aspect, the cold breeze of air can be characterized as being a stream of air having the medium speed at a colder temperature than the venue, for example, at least about 4 degrees or more colder than the temperature of the venue. In an aspect, the cold blast of air can be characterized as being a stream of air having the high speed at a colder temperature than the venue, for example, at least about 4 degrees or more colder than the temperature of the venue. In an aspect, the hot stream of air can be characterized as being a stream of air having the slow speed at a hotter temperature than the venue, for example, at least about 4 degrees or more hotter than the temperature of the venue. In an aspect, the hot breeze of air can be characterized as being a stream of air having the medium speed at a hotter temperature than the venue, for example, at least about 4 degrees or more hotter than the temperature of the venue. In an aspect, the hot blast of air can be characterized as being a stream of air having the high speed at a hotter temperature than the venue, for example, at least about 4 degrees or more hotter than the temperature of the venue. In an aspect, the scented stream of air can be characterized as being a stream of air having the idle stream of air, the breeze stream of air, the blast stream of air, the cold stream of air, the cold breeze stream of air, the cold blast stream of air, the warm stream of air, the warm breeze stream of air, and/or the warm blast stream of air that has been infused with one or more scents.

The atmospheric effects 820 described above can include other gases and liquids dispersed in the streams of air. For example, atmospheric effects 820 can include water vapor (e.g., steam) and/or liquid water. Additionally atmospheric effects 820 can include any other food grade gas and/or liquid.

In an aspect, atmospheric effects system 800 can be situated at least partially within a venue which hosts the event. In such an aspect, atmospheric effects system 800 can present the atmospheric effects 820 to an audience within the venue to enhance the immersion of the audience as they are viewing the event. Atmospheric effects system 800 can include an effects pod 802, at least one fluid source 805, such as one or more compressed air storage tanks 804 or one or more steam generators 806, a central distribution 808, flexible conduits 810, first and second pipe assemblies 100a/b, heat trace system 812, and control distribution box (CDB) 814.

Effects pod 802 can be situated within a venue to provide atmospheric effects 820 to the audience within the venue. In an aspect, effects pod 802 can be primarily stationary within the venue. In another aspect, effects pod 802 can be a portable mobile effects pod easily relocated within the venue. Effects pod 802 can include features of the portable mobile effects pods described in U.S. application Ser. No. 16/997,511 (attorney docket no. 3804.0130000; now U.S. Pat. No. 11,260,314) and U.S. application Ser. No. 16/997,518 (attorney docket no. 3804.0140000; now U.S. Pat. No. 11,266,921).

Effects pod 802 can receive a fluid from at least one fluid source 805, for example, a compressed air storage tank 804 and/or a steam generator 806. A compressed air storage tank 804 and a steam generator 806 in the present disclosure can include features of the compressed air storage tanks and steam generators described in U.S. application Ser. No. 16/997,511 (attorney docket no. 3804.0130000; now U.S. Pat. No. 11,260,314) and U.S. application Ser. No. 16/997,518 (attorney docket no. 3804.0140000; now U.S. Pat. No. 11,266,921). Once effects pod 802 has received the fluid from at least one fluid source 805, effects pod 802 can use the fluid to produce atmospheric effects 820 such as those described above, and can emit atmospheric effects 820 into the venue. In an aspect, the fluid used to produce atmospheric effects 820 can be a food grade fluid (i.e., a fluid safe for human consumption). For example, the fluid can be steam produced from potable water that has been filtered prior to the water being supplied to a steam generator 806. More specifically, the fluid used to produce atmospheric effects 820 can be a medical grade fluid. For example, the fluid can be steam produced from water that has undergone reverse osmosis filtering and deionization. Additionally, the water can be purified using an ultraviolet water purifier and/or filtered to remove particles 1 micron or larger in diameter.

In an aspect, effects pod 802 can receive a fluid from at least one fluid source 805 via central distribution 808. Central distribution 808 can control the flow, pressure, and temperature of a fluid received from at least one fluid source 805 and provide the fluid to effects pod 802. Pipe assemblies 100 can be coupled to central distribution 805 to transport the fluid from at least one fluid source 805 to effects pod 802. Central distribution can support connections to any suitable number of pipe assemblies 100 and effects pods 802, depending on the size and needs of the venue. In another aspect, system 800 can operate without central distribution 808, and the fluid can be transported directly from at least one of a compressed air storage tank 804 or a steam generator 806 to effects pod 802.

To transport fluid from a fluid source 805 to effects pod 802, atmospheric effects system 800 can implement pipe assemblies 100, such as first pipe assembly 100a and/or second pipe assembly 100b. As shown in FIG. 8, in an aspect, pipe assemblies 100 can be coupled to a fluid source 805 via central distribution 808 and/or flexible conduits 810 (e.g., hoses). Further, pipe assemblies 100 can be coupled to effects pod 802 via flexible conduits 810. Flexible conduits 810 can be coupled to pipe assemblies 100 by attaching to connectors 108 of pipe assemblies 100. Flexible conduits 810 can allow the position and angle of pipe assemblies 100 with respect to central distribution 808 and effects pod 802 to be adjusted. For example, the position and angle of a pipe assembly 100 can be adjusted while the pipe assembly 100 is coupled to effects pod 802 via a flexible conduit 810. Additionally, flexible conduits 810 can allow for thermal expansion of pipes 102 of pipe assemblies 100 when a heated fluid is passed through a combination of pipe assemblies 100 and flexible conduits 810. Particularly, flexible conduits 810 can accommodate the growth of pipes 102 caused by the thermal expansion, such that the expansion of pipes 102 does not cause ruptures or other damage along a connected plurality of pipe assemblies.

Flexible conduits 810 can be steam-rated hoses. For example, in an aspect in which a heat trace is in contact with a flexible conduit 810, as discussed below with respect to heat trace system 812, the flexible conduit 810 can be capable of withstanding the maximum temperature the heat trace is capable of generating (e.g., about 200° C.). Further, the flexible conduit 810 can be capable of withstanding the expected maximum pressure of the fluid passing through the flexible conduits (e.g., about 200 PSI). Flexible conduits 810 being steam-rated hoses can prevent flexible conduits 810 from melting due to contact with high-temperature fluids and/or heat traces.

As shown in FIG. 8, in an aspect, first pipe assembly 100a can be used to provide a high-pressure input stream of air 816 to effects pod 802. High-pressure input stream of air 816 can originate from one or more compressed air storage tanks 804. In an aspect, high-pressure input stream of air 816 can have a pressure higher than an atmospheric pressure of the venue, for example, a pressure between about 15 pounds per square inch (PSI) and about 200 PSI. Further, in an aspect, second pipe assembly 100b can be used to provide a high-temperature stream of air 818 to effects pod 802. In an aspect, high-temperature stream of air 818 can originate from one or more steam generators 806 and can include steam. In an aspect, high-temperature stream of air 818 can have a temperature between about 100° C. and about 200° C. High-pressure input stream of air 816 and/or high-temperature stream of air 818 can include other gases and liquids dispersed in the streams of air. For example, high-pressure input stream of air 816 and/or high-temperature stream of air 818 can include water vapor (e.g., steam) and/or liquid water, or any other food grade gas and/or liquid.

While FIG. 8 shows two distinct streams of air 816, 818, first pipe assembly 100a and/or second pipe assembly 100b can be used to provide a high-pressure/high-temperature stream of air originating from both a compressed air storage tank 804 and a steam generator 806. Further, while FIG. 8 shows both high-pressure input stream of air 816 and high-temperature stream of air 818, system 800 can include one or more compressed air storage tanks 804 without one or more steam generators 806. Or, system 800 can include one or more steam generators 806 without one or more compressed air storage tanks. Accordingly, system 800 can be used to provide only high-pressure input stream of air 816 or only high- temperature stream of air 818.

Heat trace system 812 can control a temperature of a fluid being transported from at least one fluid source 805 to effects pod 802. Heat trace system can include a heat trace 104 of first pipe assembly 100a and/or a heat trace 104 of second pipe assembly 100b. In an aspect, both first and second pipe assemblies 100a/b can include a heat trace 104. In another aspect, first pipe assembly 100a can include a heat trace 104 while second pipe assembly 100b can be utilized without a heat trace 104. In another aspect, second pipe assembly 100b can include a heat trace 104 while first pipe assembly 100a can be utilized without a heat trace 104. In another aspect, both first and second pipe assemblies 100a/b can be utilized without a heat trace 104.

In an aspect, heat trace system 812 can further include heat traces in contact with flexible conduits 810. Within heat trace system 812, a first electrical connector 112a coupled to a heat trace 104 of a pipe assembly 100 can couple to a heat trace in contact with a flexible conduit 810. Further, a second electrical connector 112b coupled to the opposite end of the heat trace 104 of the pipe assembly 100 can couple to a heat trace in contact with another flexible conduit 810. In another aspect, heat trace system can include only heat traces 104 in contact with pipe assemblies 100.

Control distribution box (CDB) 814 can control heat trace system 812 to control the temperature of a fluid being transported from at least one fluid source 805 to effects pod 802. Further, CDB 814 can be positioned nearby central distribution 808 and can regulate disbursement of fluids from central distribution 808 and/or the at least one fluid source 805. CDB 814 can receive information on the temperature of pipe assemblies 100 sent from sensors 107. CDB 814 can send signals to heat trace system 812 regulating the amount of power provided to heat traces in contact with flexible conduits 810 and/or heat traces 104 in contact with pipe assemblies 100, thus increasing or decreasing the temperature of a fluid flowing through pipe assemblies 100. In an aspect, CDB 814 can regulate the amount of power provided to individual chains of heat traces within heat trace system 812. For example, CDB 814 can be communicatively coupled to a first heat trace (e.g., a heat trace in contact with a flexible conduit 810) in a chain of heat traces (e.g., including a heat trace 104 of a pipe assembly 100) connected in series, and can control the chain of heat traces simultaneously. In another aspect, CDB 814 can regulate the amount of power provided to individual heat traces within heat trace system 812.

In addition to the control system provided by CDB 814, additional atmospheric effects control modules can be included within effects pod 802. For example, airstream pressure regulation, airstream temperature configuration, or airstream scent injection devices can be included within effects pod 802 to produce atmospheric effects 820 described above. These additional control modules can receive a fluid transported from at least one fluid source 805 and use the fluid to produce atmospheric effects 820 described above. Atmospheric effects 820 can include the fluid. For example, high-pressure input stream of air 816 can be used to produce the blast stream of air, described above. As an additional example, high-temperature stream of air 818 can be used to produce the hot stream of air, described above. Further, both high-pressure input stream of air 816 and high-temperature stream of air 818 can be used to produce the hot blast of air, described above.

FIG. 9 shows atmospheric effects system 800 including a first plurality of pipe assemblies 100a and a second plurality of pipe assemblies 100b. As shown in FIG. 9, the first plurality of pipe assemblies 100a can be connected in series via at least one flexible conduit 810. Similarly, the second plurality of pipe assemblies 100b can be connected in series via at least one flexible conduit 810. Connecting first and second pluralities of pipe assemblies 100a/b in series can allow transportation of fluid from central distribution 808 to effects pod 802 over a greater distance and/or allow for greater maneuverability (e.g., fluid can be transported around obstacles or other features of a venue). While FIG. 9 shows first and second pluralities of pipe assemblies 100a/b each including two pipe assemblies 100, first and second pluralities of pipe assemblies 100a/b can each include any number of pipe assemblies 100 in accordance with the distance between central distribution 808 and effects pod 802.

In an aspect, pipe assemblies 100 within first and second pluralities of pipe assemblies 100a/b can be connected in series and to central distribution 808 or effects pod 802 via intervening flexible conduits 810 (as shown in FIG. 9). In another aspect, pipe assemblies 100 within first and second pluralities of pipe assemblies 100a/b can be connected to central distribution 808, other pipe assemblies 100, and/or effects pod 802 directly. In such an aspect, connectors 108 of pipe assemblies 100 can couple to central distribution 808, connectors 108 of other pipe assemblies 100, and/or effects pod 802. Further, in such an aspect, heat traces 104 of pipe assemblies 100 can be connected to one another in series via first and second electrical connectors 112a/b. Additionally, pipes 102 of pipe assemblies 100 can include angled portions which allow the arrangement and direction of pipe assemblies 100 connected in series to be selected.

While FIGS. 8-9 show pipe assemblies 100 being used to transport a fluid between central distribution 808 and effects pod 802, pipe assemblies 100 can also be used to transport a fluid between at least one fluid source 805 and central distribution 808.

While FIGS. 8-9 show a single effects pod 802, system 800 can include any number of effects pods 802 suitable for providing atmospheric effects to an audience in a venue, depending on the size of venue. For example, system 800 can include two, four, six, eight, 10, 12, 15, 20, 30, 50, or 100 effects pods, or any number in between. Further, while FIGS. 8-9 show two streams of air 816, 818 entering effects pod 802, in an aspect, fewer or additional streams of air can be transported to each effects pod 802 within a venue, such as one, three, four, five, or six streams of air.

In addition, in an aspect, system 800 can include an additional fluid source 805 for providing food grade or medical grade water to effects pod 802. Food grade or medical grade water can be transported from such a fluid source 805 to central distribution 808, through pipe assemblies 100, and to effects pod 802, forming a third stream of fluid or replacing one of high-pressure input stream of air 816 or high-temperature stream of air 818. In such an aspect, the food grade or medical grade water can be transported through pipe assemblies 100 at pressures greater than 40 PSI. In such an aspect, atmospheric effects 820 can include precipitation effects. In such an aspect, pipe assemblies 100 can be coupled to at least one fluid source 805 and effects pod 802 via flexible tubes 810, as shown in FIGS. 8-9 for high-pressure input stream of air 816 and high-temperature stream of air 818.

In an aspect, a fluid source 805 (e.g., a compressed air storage tank 804 or a steam generator 806) of system 800 can be spaced apart from effects pod 802 while being in the same room as effects pod 802 inside the venue. In another aspect, a fluid source 805 can be positioned in a different room from effects pod 802 inside the venue. In another aspect, fluid source 805 can be positioned outside the venue while effects pod 802 is positioned inside the venue. Accordingly, pipe assemblies 100 can be used to transport fluid from another part of a room inside a venue, another room inside a venue, or outside a venue to effects pod 802 positioned inside the venue. For an outdoor venue (e.g., a stadium, a field, etc.), “outside the venue” denotes a location outside a periphery of seating at the venue. Likewise, “inside the venue” denotes a location within the periphery of seating at the venue. For an indoor venue (e.g., an arena, a theater, an auditorium, a concert hall, etc.), “outside the venue” denotes a location outside the building containing the venue. Likewise, “inside the venue” denotes a location inside the building containing the venue.

Pipe assemblies 100 can be set up and coupled to a fluid source 805 (e.g., a compressed air storage tank 804 or a steam generator 806) using the features described herein. For example, pipe assemblies 100 can be stored in cart 500. Pipe assemblies 100 can be transported using cart 500 from a storage area to a location near central distribution 808. A pipe assembly 100 can be removed from cart 500 and coupled to central distribution 808. For example, in an aspect, the pipe assembly 100 can be coupled to central distribution 808 using a flexible conduit 810 coupled to a connector 108 at a first end of pipe assembly 100. Further, the pipe assembly 100 can be coupled to another flexible conduit 810 via the connector 108 at the second end of pipe assembly 100. If the pipe assembly 100 includes a heat trace 104, first and second electrical connectors 112a/b coupled to heat trace 104 can be coupled to heat traces in contact with the flexible conduits 810.

The pipe assembly 100 can be placed on a ground surface, resting on pipe supports 110. Lower portions 304 of pipe supports 110 can contact the ground surface to hold pipe 102 of the pipe assembly 100 a distance above the ground surface. The pipe assembly 100 can be mobile, i.e., a user can easily pick up pipe assembly 100 to reposition pipe assembly 100, as pipe supports 110 can be unfixed to the ground surface.

In an aspect, additional pipe assemblies 100 can be connected in series to the pipe assembly 100 via flexible conduits 810. In another aspect, additional pipe assemblies 100 can be connected in series to the pipe assembly 100 directly. Pipe assemblies 100 can be connected in series until a distance between central distribution 808 and effects pod 802 has been traversed. Once a fluid source 805 and effects pod 802 are coupled, effects pod 802 can provide atmospheric effects 820 produced from a fluid received from the fluid source 805 during an event.

When the event has concluded, pipe assemblies 100 can be decoupled and loaded back onto cart 500. Pipe assembles 100 can be transported using cart 500 back to a storage area.

Accordingly, pipe assemblies 100 can provide for the efficient assembly of a temporary path for fluid transportation, for example, between a fluid source 805 and an effects pod 802 used to provide atmospheric effects to an audience in a venue. Pipe supports 110 can hold pipes 102 of pipe assemblies 100 above a ground surface without substantial time and/or effort being required to fasten pipe assemblies 100 to the ground surface, a wall, or a ceiling. The distance pipe supports 110 can hold pipes 102 above the ground surface can prevent tripping by increasing visibility of pipe assemblies 100, for example, as compared to a hose lying on a ground surface. Further, insulation 106 of pipe assemblies 100 can prevent contact burns to users by maintaining a low temperature on exposed surfaces 109 of pipe assemblies 100. Additionally, pipes 102 can withstand the operating temperatures required for transporting a heated liquid to effects pod 802, and can be connected via connectors 108 and/or flexible conduits 810 without welding being required.

The Detailed Description referred to accompanying figures to illustrate exemplary aspects consistent with the disclosure. References in the disclosure to “an exemplary aspect” or “exemplary aspects” indicates that the exemplary aspect(s) described can include a particular feature, structure, or characteristic, but every exemplary aspect may not necessarily include the particular feature, structure, or characteristic. Moreover, such phrases are not necessarily referring to the same exemplary aspect. Further, any feature, structure, or characteristic described in connection with an exemplary aspect can be included, independently or in any combination, with features, structures, or characteristics of other exemplary aspects whether or not explicitly described.

The term “about” or “substantially” or “approximately” as used herein means the value of a given quantity that can vary based on a particular technology. Based on the particular technology, the term “about” or “substantially” or “approximately” can indicate a value of a given quantity that varies within, for example, 0.1-10% of the value (e.g., +0.1%, +1%, +2%, +5%, or +10% of the value).

Numerical values, including endpoints of ranges, can be expressed herein as approximations preceded by the term “about,” “substantially,” “approximately,” or the like. In such cases, other aspects include the particular numerical values. Regardless of whether a numerical value is expressed as an approximation, two aspects are included in this disclosure: one expressed as an approximation, and another not expressed as an approximation. It will be further understood that an endpoint of each range is significant both in relation to another endpoint, and independently of another endpoint.

The Detailed Description is not meant to limiting. Rather, the scope of the disclosure is defined only in accordance with the following claims and their equivalents. It is to be appreciated that the Detailed Description section, and not the Abstract section, is intended to be used to interpret the claims. The Abstract section can set forth one or more, but not all exemplary aspects, of the disclosure, and thus is not intended to limit the disclosure and the following claims and their equivalents in any way.

The exemplary aspects described within the disclosure have been provided for illustrative purposes and are not intended to be limiting. Other exemplary aspects are possible, and modifications can be made to the exemplary aspects while remaining within the spirit and scope of the disclosure. The disclosure has been described with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

Aspects of the disclosure can be implemented in hardware, firmware, software application, or any combination thereof. Aspects of the disclosure can also be implemented as instructions stored on a machine-readable medium, which can be read and executed by one or more processors. A machine-readable medium can include any mechanism for storing or transmitting information in a form readable by a machine (e.g., a computing circuitry). For example, a machine-readable medium can include non-transitory machine-readable mediums such as read only memory (ROM); random access memory (RAM); magnetic disk storage media; optical storage media; flash memory devices; and others. As another example, the machine-readable medium can include transitory machine-readable medium such as electrical, optical, acoustical, or other forms of propagated signals (e.g., carrier waves, infrared signals, digital signals, etc.). Further, firmware, software application, routines, instructions can be described herein as performing certain actions. However, it should be appreciated that such descriptions are merely for convenience and that such actions in fact result from computing devices, processors, controllers, or other devices executing the firmware, software application, routines, instructions, etc.

The Detailed Description of the exemplary aspects fully revealed the general nature of the disclosure that others can, by applying knowledge of those skilled in relevant art(s), readily modify and/or adapt for various applications such exemplary aspects, without undue experimentation, without departing from the spirit and scope of the disclosure. Therefore, such adaptations and modifications are intended to be within the meaning and plurality of equivalents of the exemplary aspects based upon the teaching and guidance presented herein. It is to be understood that the phraseology or terminology herein is for the purpose of description and not of limitation, such that the terminology or phraseology of the present specification is to be interpreted by those skilled in relevant art(s) in light of the teachings herein.

What is claimed is:

1. A system for transporting a food grade fluid from a fluid source to an effects pod to provide atmospheric effects to an audience in a venue, the system comprising:
a pipe assembly comprising:
a pipe for fluid communication with the fluid source,
a connector disposed at an end of the pipe to couple to a flexible conduit, and
a pipe support coupled to the pipe, such that a lower portion of the pipe support contacts a ground surface to hold the pipe a distance above the ground surface; and
a cart to transport the pipe assembly, the cart comprising:
a rack to retain the pipe assembly.

2. The system of claim 1, wherein the system includes a plurality of pipe assemblies to be connected in series via at least one flexible conduit.

3. The system of claim 2, wherein the rack comprises a plurality of channels to receive a plurality of pipe supports of the plurality of pipe assemblies.

4. The system of claim 1, wherein the pipe assembly further comprises:
insulation abutting at least a portion of the pipe.

5. The system of claim 4, wherein the pipe assembly further comprises:
a heat trace in contact with the pipe.

6. The system of claim 1, wherein the lower portion of the pipe support contacts the ground surface to hold the pipe the distance above the ground surface while not being fixed to the ground surface.

7. A pipe assembly, comprising:
a pipe for fluid communication with a fluid source;
a connector disposed at an end of the pipe to couple to at least one of a flexible conduit or another pipe assembly;
a pipe support coupled to the pipe, such that a lower portion of the pipe support contacts a ground surface to hold the pipe a distance above the ground surface; and
insulation abutting at least a portion of the pipe.

8. The pipe assembly of claim 7, further comprising a heat trace in contact with the pipe.

9. The pipe assembly of claim 8, further comprising a sensor to measure a temperature of an exterior surface of the pipe.

10. The pipe assembly of claim 8, wherein the heat trace is a first heat trace and the pipe assembly is a first pipe assembly, the first pipe assembly further comprising:
a first electrical connector coupled to an end of the first heat trace to couple the first heat trace to a second heat trace in contact with a first flexible conduit or a second pipe assembly; and
a second electrical connector coupled to an opposite end of the first heat trace to couple the first heat trace to a third heat trace in contact with a second flexible conduit or a third pipe assembly.

11. The pipe assembly of claim 8, wherein the pipe assembly can sustain a temperature of at least about 150° C. on the exterior surface of the pipe

12. The pipe assembly of claim 11, wherein the pipe assembly can sustain a temperature under about 50° C. on an exposed surface of the pipe assembly.

13. The pipe assembly of claim 7, wherein the fluid source is a source of food grade fluid.

14. The pipe assembly of claim 7, wherein an interior surface of the pipe comprises a food grade material.

15. The pipe assembly of claim 14, wherein the pipe comprises stainless steel.

16. A method for transporting a fluid from a fluid source to an effects pod to provide atmospheric effects to an audience in a venue, the method comprising:
coupling a pipe assembly to the fluid source, the pipe assembly comprising:
a pipe for fluid communication with the fluid source,
a heat trace in contact with the pipe,
insulation abutting at least a portion of the pipe and the heat trace, and
a pipe support coupled to the pipe, such that a lower portion of the pipe support contacts a ground surface to hold the pipe a distance above the ground surface;
coupling the pipe assembly to the effects pod; and
controlling a temperature of a fluid using a controller coupled to the heat trace while transporting the fluid from the fluid source, through the pipe, and to the effects pod, the atmospheric effects comprising the fluid.

17. The method of claim 16, further comprising coupling the pipe assembly to at least one of the effects pod or the fluid source using a flexible conduit.

18. The method of claim 16, wherein the pipe support is not fixed to the ground surface.

19. The method of claim 16, wherein the fluid source is a steam generator.

20. The method of claim 16, wherein the fluid is food grade.
